(19) United States
(12) Patent Application Publication
(10) Pub. No.: US 2013/0076607 A1
(43) Pub. Date: Mar. 28, 2013

(54) DISPLAY DEVICE

(71) Applicants: Eiji Matsuda, Osaka-shi (JP); Makoto Yokoyama, Osaka-shi (JP); Shuji Nishi, Osaka-shi (JP); Takahiro Yamaguchi, Osaka-shi (JP); Takuya Hachida, Osaka-shi (JP); Seijirou Gyouten, Osaka-shi (JP)

(72) Inventors: Eiji Matsuda, Osaka-shi (JP); Makoto Yokoyama, Osaka-shi (JP); Shuji Nishi, Osaka-shi (JP); Takahiro Yamaguchi, Osaka-shi (JP); Takuya Hachida, Osaka-shi (JP); Seijirou Gyouten, Osaka-shi (JP)

(73) Assignee: SHARP KABUSHIKI KAISHA, Abeno-ku, Osaka-shi, Osaka (JP)

(21) Appl. No.: 13/701,885

(22) PCT Filed: May 11, 2011
(86) PCT No.: PCT/JP2011/060884

§ 371 Date: Dec. 4, 2012

(30) Foreign Application Priority Data
Jun. 30, 2010 (JP) 2010-150284

(51) Int. Cl. G09G 3/36

(52) U.S. Cl. CPC G09G 3/3674
USPC 345/87

(57) ABSTRACT

A plurality of the display panels (10A and 10B) are provided on a single substrate. For each of the plurality of the display panels (10A and 10B), there are provided data signal lines (11A and 11B), scanning signal lines (12A and 12B), data signal line drive circuits (20A and 20B) which drive the respective data signal lines (11A and 11B) and scanning signal line drive circuits (30A and 30B) which drive the respective scanning signal lines (12A and 12B). This allows achievement of lower electric power consumption and greater design freedom in a display device including a plurality of display panels which are provided on a single substrate.

### TECHNICAL FIELD

The present invention relates to a display device including a plurality of display panels.

### BACKGROUND ART

Conventionally, in order to provide a smaller and/or lighter electronic device (e.g., mobile phone), a technique has been proposed for providing a plurality of display panels on one (1) substrate (see Patent Literature 1, for example).

FIG. 14 is a plan view showing an arrangement of a liquid crystal display device of Patent Document 1. The liquid crystal display device includes a first display panel (a main panel 130) and a second display panel (a sub panel 140) which are provided in respective different regions of a single glass substrate 120. The liquid crystal display device further includes a drain line (a data signal line), a source driver (a data signal line drive circuit), a gate driver (a scanning signal line drive circuit), and the like which are shared by the main panel 130 and the sub panel 140.

According to the arrangement, it is possible to (i) display different screen images on the main panel 130 and the sub panel 140 and (ii) provide a smaller liquid crystal display device and a smaller electronic device including such a liquid crystal display device.

### CITATION LIST

### Patent Literature

Patent Literature 1
Japanese Patent Application Publication, Tokukai, No. 2004-70218 (Publication Date: Mar. 4, 2004)

### SUMMARY OF INVENTION

### Technical Problem

However, according to the technique described earlier as a conventional technique, the gate driver is shared by the main panel 130 and the sub panel 140. This causes a problem of unnecessary consumption of electric power.

For example, even in a case where an image is displayed only in the main panel 130 while the sub panel 140 is in a non-display state, each shift register constituting the gate driver sequentially operates. This results in a waste of electric power consumed by operation of a shift register corresponding to the sub panel 140.

The source driver and the drain line are also provided so as to be shared by the main panel 130 and the sub panel 140. Therefore, it is impossible to drive these panels in different methods. This causes a problem of less design freedom.

In view of the problems, an object of the present invention is to achieve lower electric power consumption and greater design freedom in a display device including a plurality of display panels which are provided on a single substrate.

### Solution to Problem

As described earlier, a display device in accordance with the present invention includes: a plurality of display panels which are provided on a single substrate; a plurality of data signal lines which are provided for each of the plurality of display panels; a plurality of scanning signal lines which are provided for each of the plurality of display panels; a data signal line drive circuit which is provided for each of the plurality of display panels and drives the plurality of data signal lines; and a scanning signal line drive circuit which is provided for each of the plurality of display panels and drives the plurality of scanning signal lines.

According to the arrangement, display panels are provided in respective different regions of a single substrate, and drive circuits and signal lines are provided for each of the plurality of display panels. This makes it possible to drive the display panels separately. For example, assume that two display panels which are a display panel A and a display panel B are provided. In this case, in accordance with a situation in which the display panel A and the display panel B are used, driving of the display panel A and the display panel B can be controlled such that (1) both the display panel A and the display panel B are driven, (2) the display panel A is driven, and the display panel B is not driven, (3) the display panel A is not driven, and the display panel B is driven, or (4) neither the display panel A nor the display panel B is driven. This enables lower electric power consumption and greater design freedom.

As described earlier, a display device in accordance with the present invention includes: a plurality of display panels which are provided on a single substrate; a plurality of data signal lines which are provided for each of the plurality of display panels; a plurality of scanning signal lines which are provided for each of the plurality of display panels; a data signal line drive circuit which is provided for each of the plurality of display panels and drives the plurality of data signal lines; and a scanning signal line drive circuit which is provided for each of the plurality of display panels and drives the plurality of scanning signal lines.

This allows achievement of lower electric power consumption and greater design freedom in a display device including a plurality of display panels which are provided on a single substrate.

### BRIEF DESCRIPTION OF DRAWINGS

FIG. 1

FIG. 1 is a block diagram illustrating an overall arrangement of a liquid crystal display device of First Embodiment.

FIG. 2

(a) of FIG. 2 is an equivalent circuit diagram illustrating an electrical configuration of one (1) pixel of a display panel 10A of the liquid crystal display device of First Embodiment. (b) of FIG. 2 is an equivalent circuit diagram illustrating an electrical configuration of one (1) pixel of a display panel 10B of the liquid crystal display device of First Embodiment.

FIG. 3

(a) of FIG. 3 is a timing chart of input signals in the display panel 10A. (b) of FIG. 3 is a timing chart of input signals in the display panel 10B.

FIG. 4

(a) of FIG. 4 illustrates a range of a supply voltage which is supplied to the display panel 10A. (b) of FIG. 4 illustrates a range of a supply voltage which is supplied to the display panel 10B.

FIG. 5

FIG. 5 is a schematic cross-sectional view taken along arrows X-Y of FIG. 1.

FIG. 6

FIG. 6 is a block diagram showing a method for driving the liquid crystal display device of First Embodiment.

FIG. 7

FIG. 7 is an equivalent circuit diagram partially illustrating the display panel 10A and the display panel 10B of a liquid crystal display device in accordance with an arrangement example 1.

FIG. 8

FIG. 8 is an equivalent circuit diagram partially illustrating the display panel 10A and the display panel 10B of a liquid crystal display device in accordance with an arrangement example 2.

FIG. 9

FIG. 9 is an equivalent circuit diagram partially illustrating the display panel 10A and the display panel 10B of a liquid crystal display device in accordance with an arrangement example 3.

FIG. 10

FIG. 10 is a block diagram illustrating an overall arrangement of a liquid crystal display device of Second Embodiment.

FIG. 11

FIG. 11 is a schematic cross-sectional view taken along arrows X-Y of FIG. 10.

FIG. 12

(a) of FIG. 12 illustrates a waveform of a voltage to be supplied to a counter electrode 15A (counter DC drive) and a waveform of a voltage to be supplied to a counter electrode 15B (counter AC drive) in the liquid crystal display device of Second Embodiment. (b) of FIG. 12 illustrates a waveform of a voltage to be supplied to the counter electrode 15A (counter AC drive) and a waveform of a voltage to be supplied to the counter electrode 15B (counter AC drive) in the liquid crystal display device of Second Embodiment.

FIG. 13

FIG. 13 is a block diagram illustrating an overall arrangement of a liquid crystal display device in accordance with an arrangement example 4.

FIG. 14

FIG. 14 is a block diagram illustrating an arrangement of a conventional display device.

### DESCRIPTION OF EMBODIMENTS

### First Embodiment

First Embodiment of the present invention is described below with reference to the drawings. Note that for convenience of explanation, it is assumed that a direction in which data signal lines extend is a column direction and a direction in which scanning signal lines extend is a row direction. However, it goes without saying that the scanning signal lines can extend in either a transverse direction or a longitudinal direction depending on a state in which a liquid crystal display device of the present embodiment (or a liquid crystal panel and an active matrix substrate which are used for the liquid crystal display device) is used (viewed). Note also that one (1) pixel region of the active matrix substrate corresponds to one (1) pixel of the liquid crystal panel.

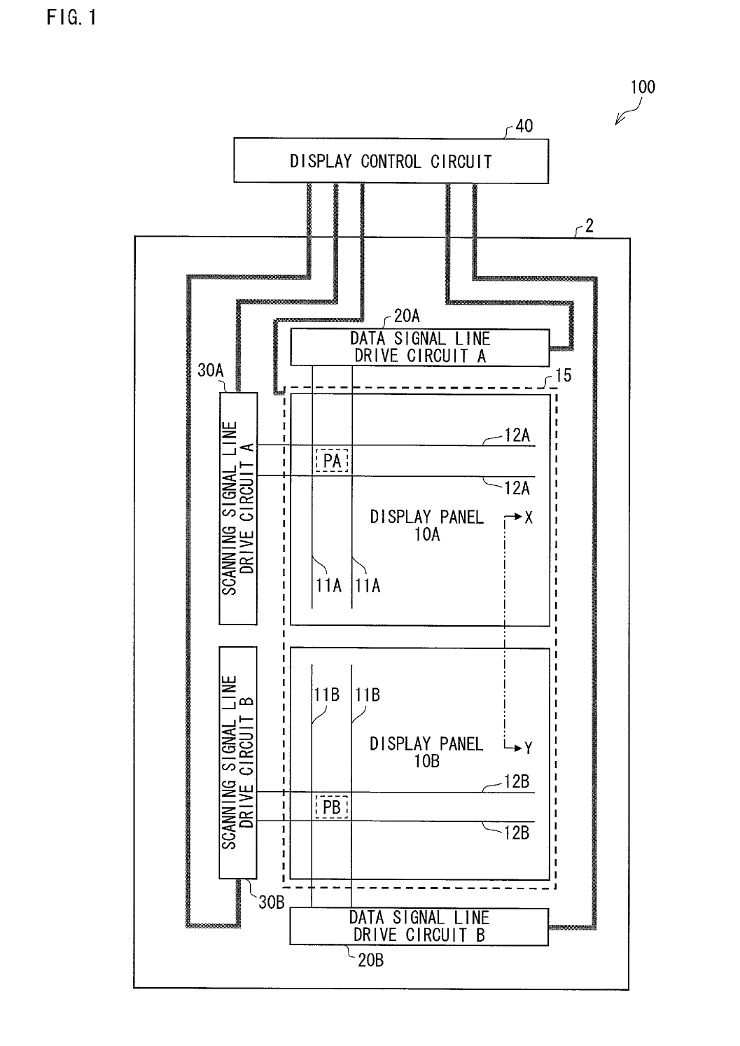

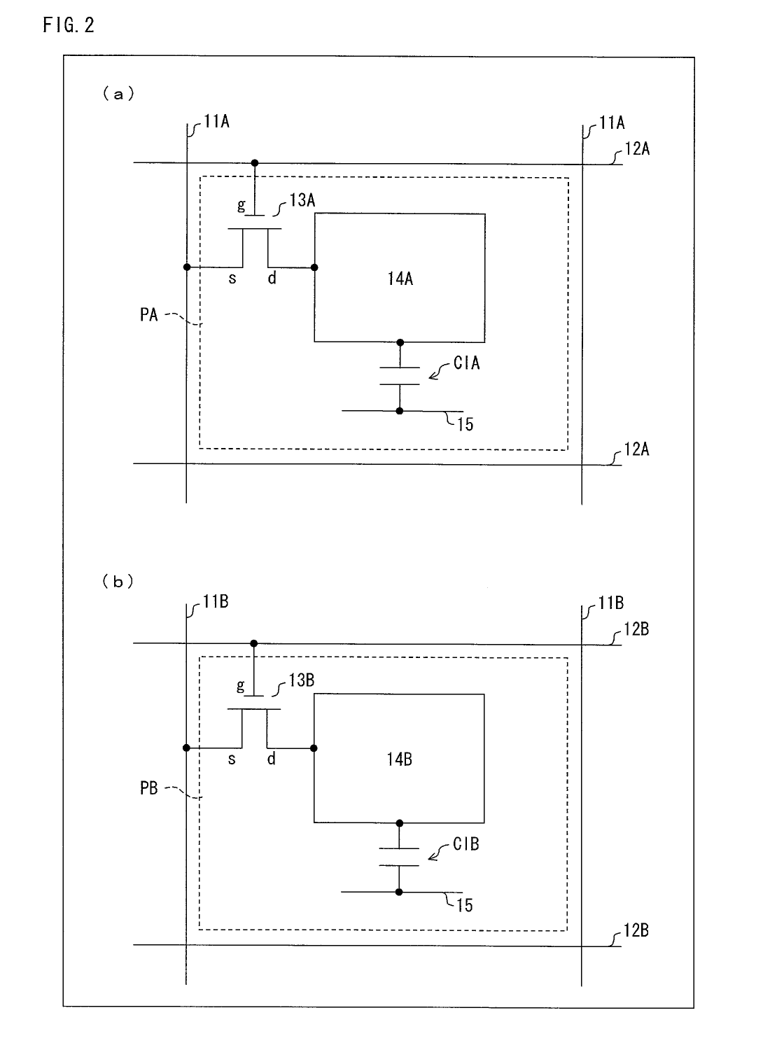

First, the following description will discuss, with reference to FIG. 1 and FIG. 2, an arrangement of a liquid crystal display device 100 corresponding to a display device of the present invention. FIG. 1 is a block diagram illustrating an overall arrangement of the liquid crystal display device 100. (a) of FIG. 2 is an equivalent circuit diagram illustrating an electrical configuration of one (1) pixel of a display panel 10A of the liquid crystal display device 100. (b) of FIG. 2 is an equivalent circuit diagram illustrating an electrical configuration of one (1) pixel of a display panel 10B of the liquid crystal display device 100.

The liquid crystal display device 100 includes the display panel 10A and the display panel 10B, a data signal line drive circuit 20A and a data signal line drive circuit 20B, a scanning signal line drive circuit 30A and a scanning signal line drive circuit 30B, and a display control circuit 40.

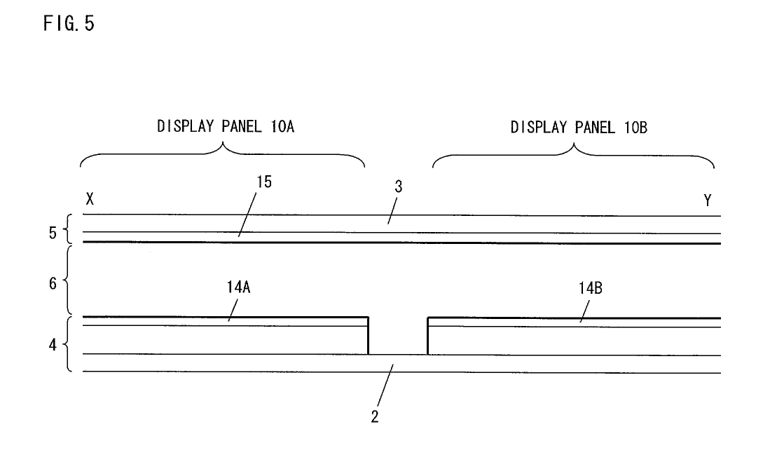

The display panel 10A and the display panel 10B are provided in respective different regions of a single glass substrate 2. The display panel 10A is provided with data signal lines 11A, scanning signal lines 12A, transistors 13A, and pixel electrodes 14A. Pixels PA are provided at intersections of the data signal lines 11A and the scanning signal lines 12A. The display panel 10B is provided with data signal lines 11B, scanning signal lines 12B, transistors 13B, and pixel electrodes 14B. Pixels PB are provided at intersections of the data signal lines 11B and the scanning signal lines 12B. Note that a counter electrode (a common electrode) 15 shared by the display panel 10A and the display panel 10B is provided on a counter substrate 3 (see FIG. 5) and the counter electrode 15 is supplied with a constant electric potential (com).

According to the display panel 10A, the data signal lines 11A are provided in respective columns so as to be parallel to each other in a column direction (a longitudinal direction, a vertical direction in the drawings), and the scanning signal lines 12A are provided in respective rows so as to be parallel to each other in a row direction (a transverse direction, a horizontal direction in the drawings). The transistors 13A and the pixel electrodes 14A are provided at the intersections of the data signal lines 11A and the scanning signal lines 12A. Each of the transistors 13A has a source electrode s which is connected to a corresponding data signal line 11A, a gate electrode g which is connected to a corresponding scanning signal line 12A, and a drain electrode d which is connected to the pixel electrode 14A. A liquid crystal capacitor CIA is defined between each of the pixel electrodes 14A and the counter electrode 15 via a liquid crystal (see (a) of FIG. 2).

According to this, a gate of a transistor 13A is turned on by a gate signal (a scanning signal) supplied to a scanning signal line 12A. When a source signal (a data signal) supplied from a data signal line 11A is written to a pixel electrode 14A, an electric potential in accordance with the source signal is applied to the pixel electrode 14A. As a result, a voltage in accordance with the source signal is applied to a liquid crystal provided between the pixel electrode 14A and the counter electrode 15. This enables a gradation display in accordance with the source signal.

According to the display panel 10B, the data signal lines 11B are provided in respective columns so as to be parallel to each other in a column direction (a longitudinal direction, a vertical direction in the drawings), and the scanning signal lines 12B are provided in respective rows so as to be parallel to each other in a row direction (a transverse direction, a horizontal direction in the drawings). The transistors 13B and the pixel electrodes 14B are provided at the intersections of the data signal lines 11B and the scanning signal lines 12B. Each of the transistors 13B has a source electrode s which is connected to a corresponding data signal line 11B, a gate electrode g which is connected to a corresponding scanning signal line 12B, and a drain electrode d which is connected to the pixel electrode 14B. A liquid crystal capacitor CIB is defined between each of the pixel electrodes 14B and the counter electrode 15 via a liquid crystal (see (a) of FIG. 2).

According to this, a gate of a transistor 13B is turned on by a gate signal (a scanning signal) supplied to a scanning signal line 12B. When a source signal (a data signal) supplied from a data signal line 11B is written to a pixel electrode 14B, an electric potential in accordance with the source signal is applied to the pixel electrode 14B. As a result, a voltage in accordance with the source signal is applied to a liquid crystal provided between the pixel electrode 14B and the counter electrode 15. This enables a gradation display in accordance with the source signal.

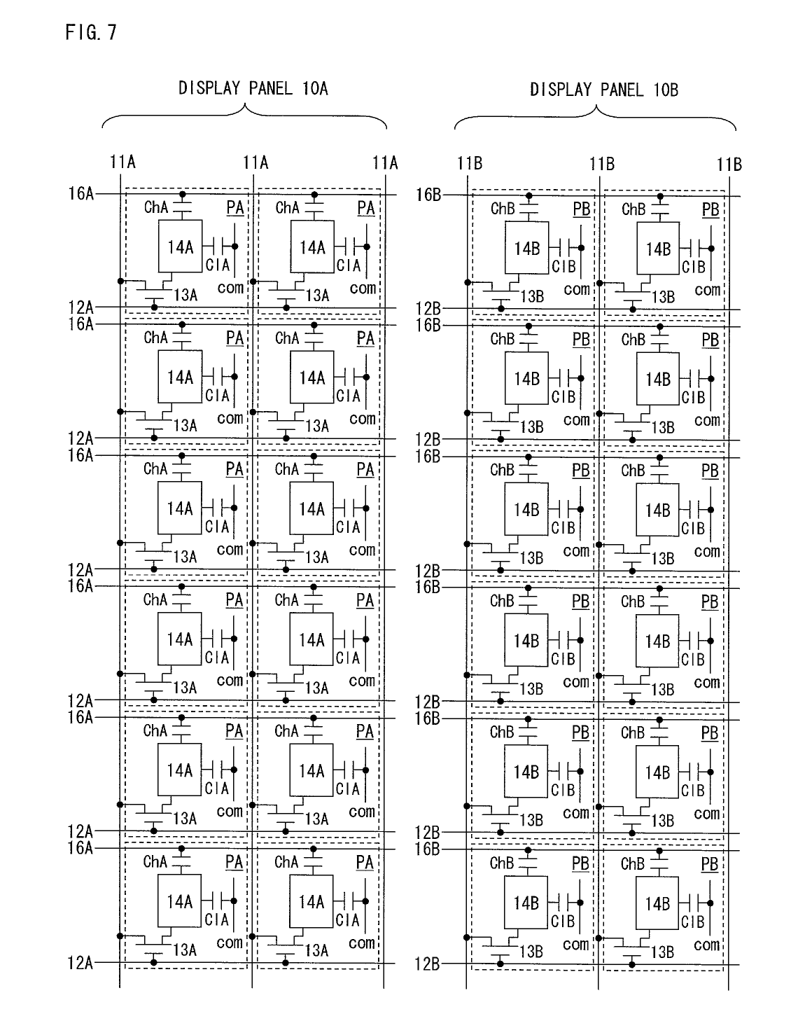

Note that the liquid crystal display device 100 can be provided with retention capacitor lines. In this case, the display panel 10A is arranged such that the retention capacitor lines 16A are provided in respective rows so as to be parallel to each other in a row direction (a transverse direction) and to be paired with the respective scanning signal lines 12A (see FIG. 7). The retention capacitor lines 16A are capacitively coupled with the pixel electrodes 14A in a case where retention capacitors ChA are defined between the retention capacitor lines 16A and the pixel electrodes 14A provided in respective rows. The display panel 10B is arranged such that the retention capacitor lines 16B are provided in respective rows so as to be parallel to each other in a row direction (a transverse direction) and to be paired with the respective scanning signal lines 12B (see FIG. 7). The retention capacitor lines 16B are capacitively coupled with the pixel electrodes 14B in a case where retention capacitors ChB are defined between the retention capacitor lines 16B and the pixel electrodes 14B provided in respective rows. An arrangement of the display panel 10A and the display panel 10B which include the retention capacitors 16A and the retention capacitors 16B, respectively is described later (see FIG. 7).

The display panel 10A having the arrangement is driven by the data signal line drive circuit 20A and the scanning signal line drive circuit 30A. The display panel 10B is driven by the data signal line drive circuit 20B and the scanning signal line drive circuit 30B. The display control circuit 40 supplies, to each of the data signal line drive circuit 20A and the scanning signal line drive circuit 30A, various signals which are necessary for driving the display panels 10A. The display control circuit 40 also supplies, to each of the data signal line drive circuit 20B and the scanning signal line drive circuit 30B, various signals which are necessary for driving the display panels 10B. Note that the display control circuit 40 can be provided in an external region which is different from a region in which the drive circuits are provided. Alternatively, the display control circuit 40 and the drive circuits can be provided on a single substrate.

According to First Embodiment of the present invention, in an active period (effective scanning period) of a vertical scanning period which is periodically repeated, each row is allotted a horizontal scanning period sequentially, and the each row is scanned sequentially. Therefore, according to the display panel 10A, in sync with the horizontal scanning period in the each row, the scanning signal line drive circuit 30A supplies a gate signal for turning on the transistors 13A to a scanning signal line 12A in the each row. According to the display panel 10B, in sync with the horizontal scanning period in the each row, the scanning signal line drive circuit 30B supplies a gate signal for turning on the transistors 13B to a scanning signal line 12B in the each row.

According to the display panel 10A, the data signal line drive circuit 20A supplies a source signal to each of the data signal lines 11A. According to the display panel 10B, the data signal line drive circuit 20B supplies a source signal to each of the data signal lines 11B. These source signals are obtained by allotting, to each column in the data signal line drive circuit 20A and the data signal line drive circuit 20B, respectively, video signals which have been supplied from an outside of the liquid crystal device 100 via the display control circuit 40 to the data signal line drive circuit 20A and the data signal line drive circuit 20B, respectively, and subjecting the video signals to a boost or the like.

The display control circuit 40 controls the data signal line drive circuit 20A and the data signal line drive circuit 20B (which are described earlier), and the scanning signal line drive circuit 30A and the scanning signal line drive circuit 30B (which are described earlier), so as to supply various signals from these circuits. Note that a specific method for driving the circuits will be described later.

As described earlier, the liquid crystal display device 100 includes the display panel 10A and the display panel 10B which are provided in respective different regions of the single substrate 2, and the drive circuits and the signal lines which are provided so as to correspond to each of the display panel 10A and the display panel 10B. This allows the display panel 10A and the display panel 10B to be driven separately.

Therefore, the display panel 10A and the display panel 10B can be driven in different methods.

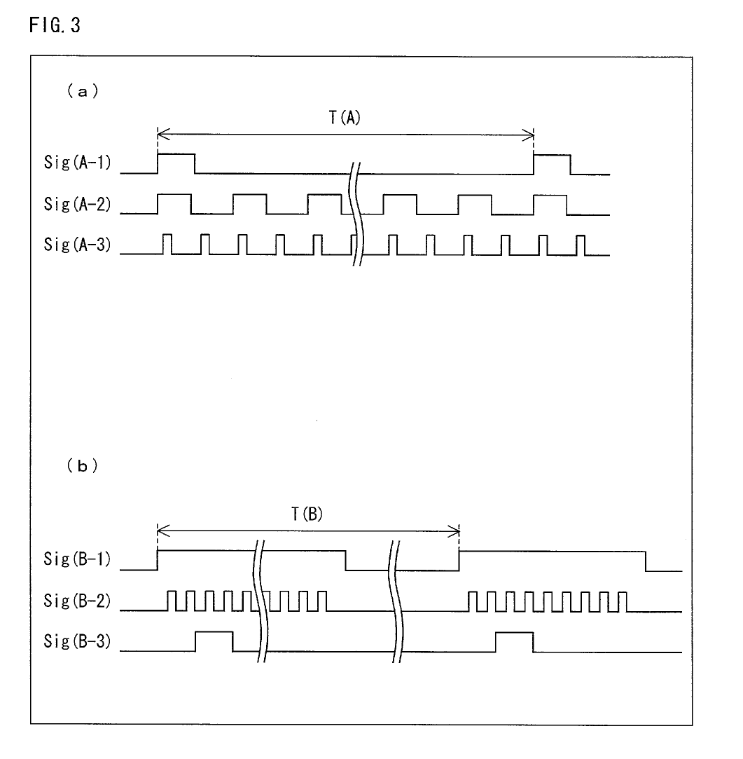

(a) of FIG. 3 is a timing chart of input signals (Sig (A-1), Sig (A-2), and Sig (A-3)). (b) of FIG. 3 is a timing chart of input signals (Sig (B-1), Sig (B-2), and Sig (B-3)). It is possible to differentiate frequencies of, periods (e.g, T(A) and T(B)) of, and duty ratios of input signals between the display panel 10A and the display panel 10B (see FIG. 3).

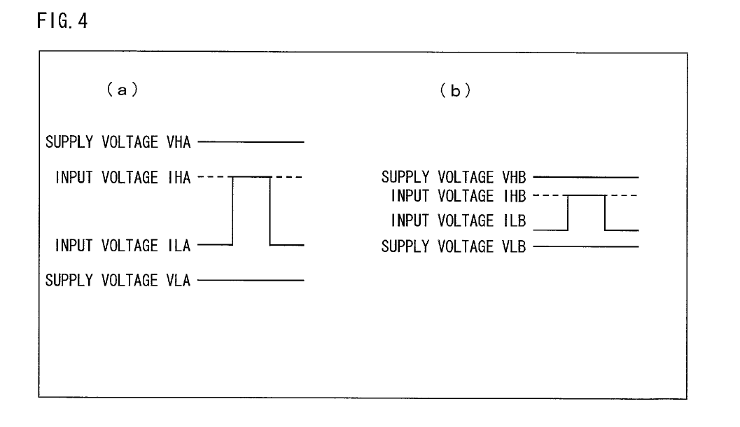

(a) of FIG. 4 illustrates a range of a supply voltage which is supplied to the display panel 10A. (b) of FIG. 4 illustrates a range of a supply voltage which is supplied to the display panel 10B. For example, the display panel 10A can be set to have (i) a high electric potential side supply voltage VHA which is higher than a high electric potential side supply voltage VHB of the display panel 10B and (ii) a low electric potential side supply voltage VLA which is lower than a low electric potential side supply voltage VLB of the display panel 10B. This allows the display panel 10A to be wider in range of an input voltage than the display panel 10B. Specifically, for example, it is possible to set VHA to 10 V, VLA to −5 V, VHB to 5 V, and VLB to 0 V.

As described earlier, various signals can be set in accordance with each of the display panel 10A and the display panel 10B. Therefore, for example, the display panel 10A can be arranged to carry out 1-line (1H) inversion driving, and the display panel 10B can be arranged to carry out 2-line (2H) inversion driving. In this case, the data signal line drive circuit 20A is arranged such that a polarity of the source signal which is supplied from the data signal line drive circuit 20A is identical for all pixels in an identical row and is reversed for each line. The data signal line drive circuit 20B is arranged such that a polarity of the source signal which is supplied from the data signal line drive circuit 20B is identical for all pixels in an identical row and is reversed every 2 lines.

In addition, the display panel 10A and the display panel 10B can carry out a display at respective different resolutions. For example, the display panel 10A can carry out an actual-size display, and the display panel 10B can carry out a double-size display. In this case, in order to carry out a display by doubling a resolution of a video signal in line and column directions, the data signal line drive circuit 20A causes source signals to be supplied to the first row and the second row, respectively, to be equal in voltage polarity and gradation, and causes source signals to be supplied to the third row and the fourth row, respectively, to be equal in voltage polarity and gradation.

A method for driving the liquid crystal display device 100 of the present embodiment is not limited to driving methods described above, various driving methods are applicable to the liquid crystal display device 100.

According to the liquid crystal display device 100 of the present embodiment, the display panel 10A and the display panel 10B can be separately controlled. Therefore, driving of the display panel 10A and the display panel 10B can be controlled in accordance with a situation in which the display panel 10A and the display panel 10B are used. For example, the driving of the display panel 10A and the display panel 10B can be controlled such that (1) both the display panel 10A and the display panel 10B are driven, (2) the display panel 10A is driven, and the display panel 10B is not driven, (3) the display panel 10A is not driven, and the display panel 10B is driven, or (4) neither the display panel 10A nor the display panel 10B is driven.

Note here that for example, according to an arrangement (see the above (3)) such that the display panel 10A is not driven, and the display panel 10B is driven, the data signal line drive circuit 20A and the scanning signal line drive circuit 30A can be in a stop state by setting each of a driving signal and the supply voltage of the display panel 10A to GND. The data signal line drive circuit 20A and the scanning signal line drive circuit 30A can be in a standby state by setting the drive signal to GND and setting the supply voltage to an ordinary voltage.

According to the arrangement, driving of one of the display panels can be completely stopped. This enables lower electric power consumption.

A cross sectional arrangement of liquid crystal display device 100 of the present embodiment is described here. FIG. 5 is a schematic cross-sectional view taken along arrows X-Y of FIG. 1. Note that each signal line and each insulating film, whose arrangements are well known, are not illustrated in FIG. 5.

The display panel 10A and the display panel 10B of the present embodiment include an active matrix substrate 4 and a color filter substrate 5 which faces the active matrix substrate 4, and a liquid crystal layer 6 which is provided between the active matrix substrate 4 and the active matrix substrate 5 (see FIG. 5). According to the active matrix substrate 4, on the glass substrate 2 (substrate), the scanning signal lines 12A (not illustrated) are provided in a region in which the display panel 10A is provided, and the scanning signal lines 12B (not illustrated) are provided in a region in which the display panel 10B is provided. A gate insulating film (not illustrated) is provided so as to cover the scanning signal lines 12A and the scanning signal lines 12B. On the gate insulating film, the data signal lines 11A (not illustrated) are provided in a region in which the display panel 10A is provided, and the data signal lines 11B (not illustrated) are provided in a region in which the display panel 10B is provided. Note that semiconductor layers (an i layer and an n+ layer) of each transistor 13A and each transistor 13B (which are not illustrated), and source electrodes and drain electrodes each of which is in contact with the n+ layer are provided on the gate insulating film for each of the display panel 10A and the display panel B. Furthermore, an inorganic interlayer insulating film (not illustrated) is provided so as to cover a metal layer in which the data signal lines are provided, and an organic interlayer insulating film (not illustrated) thicker than the inorganic interlayer insulating film is provided on the inorganic interlayer insulating film. On the organic interlayer insulating film, the pixel electrodes 14A are provided in a region in which the display panel 10A is provided, and the pixel electrodes 14B are provided in a region in which the display panel 10B is provided. Further, an alignment film is provided so as to cover the pixel electrodes.

According to the color filter 5, there are provided a glass substrate (a counter substrate) 3, a black matrix (not illustrated) and a colored layer (a color filter layer) (not illustrated) which are provided on the glass substrate 3, the counter electrode 15 which is provided on the colored layer so as to be shared by the respective regions in which the display panel 10A and the display panel 10B are provided, and an alignment film which is provided so as to cover the counter electrode 15.

The following description discusses a method for producing the display panel 10A and the display panel 10B having the arrangement. The method for producing the display panel 10A and the display panel 10B includes the steps of: (a) producing the active matrix substrate 4; (b) producing the color filter substrate 5; and (c) carrying out an assembly in which the liquid crystal is filled between the active matrix substrate 4 and the color filter substrate 5 which have been combined.

First, (i) a metal film made of a material such as titanium, chromium, aluminum, molybdenum, tantalum, tungsten, or copper, (ii) an alloy film of such materials, or (iii) a film in which (a) at least two metal films each made of the material are stacked, (b) at least two alloy films each made of the materials are stacked, or (c) at least one metal film made of the material and at least one alloy film made of the materials are stacked, is deposited on a substrate (the glass substrate 2 in FIG. 5) made of a material such as glass or plastic by a sputtering method so as to have a thickness of 1000 Å to 3000 Å. Then, the film (i), (ii), or (iii) thus deposited is patterned by a photolithographic technique (Photo Engraving Process, hereinafter referred to as a “PEP technique”, and including an etching process). This causes formations of the scanning signal lines 12A and the scanning signal lines 12B (the gate electrodes of respective of the transistors 13A and the transistors 13B), and the retention capacitor lines (not illustrated).

Next, an inorganic insulating film which is made of a material such as silicon nitride or oxide silicon and has a thickness of approximately 3000 Å to 5000 Å is deposited by a CVD (Chemical Vapor Deposition) method, and photoresist is removed. This causes a formation of a gate insulating film throughout the substrate on which the scanning signal lines 12A and the scanning signal lines 12B have been formed.

Subsequently, (i) an intrinsic amorphous silicon film which has a thickness of 1000 Å to 3000 Å and (ii) an n+ amorphous silicon film which has a thickness of 400 Å to 700 Å and to which phosphorus is added are sequentially deposited on the gate insulating film (throughout the substrate) by the CVD method. Then, the intrinsic amorphous silicon film and the n+ amorphous silicon film are patterned by the PEP technique, and photoresist is removed, so that a silicon stacked layer in which an intrinsic amorphous silicon layer and an n+ amorphous silicon layer are stacked is island-shaped on the gate electrodes.

Subsequently, throughout the substrate on which the silicon stacked layer has been formed, (i) a metal film made of a material such as titanium, chromium, aluminum, molybdenum, tantalum, tungsten, or copper, (ii) an alloy film of such materials, or (iii) a film in which (a) at least two metal films each made of the material are stacked, (b) at least two alloy films each made of the materials are stacked, or (c) at least one metal film made of the material and at least one alloy film made of the materials are stacked, is deposited on a substrate made of a material such as glass or plastic by a sputtering method so as to have a thickness of 1000 Å to 3000 Å. Then, such a film is patterned by the PEP technique. This causes formations of the data signal lines 11A and the data signal lines 11B, the source electrodes and the drain electrodes of respective of the transistors 13A and the transistors 13B, drain drawing electrodes, capacitor electrodes, and extending wires (a formation of a metal layer). Photoresist is removed here, if necessary.

While causing the photoresist used for a formation of metal wiring or the source electrodes and the drain electrodes to serve as a mask, the n+ amorphous silicon layer constituting the silicon stacked layer is removed by etching so that channels of the respective transistors are formed. Note here that a semiconductor layer can be formed by an amorphous silicon film as described earlier or by a polysilicon film. Alternatively, a laser annealing treatment can be carried out with respect to an amorphous silicon film or a polysilicon film so that the semiconductor layer can have a better crystallinity. Since this causes an increase in mobility of electrons in the semiconductor layer, a transistor (TFT) characteristic can be improved.

Next, an interlayer insulating film is deposited throughout the substrate on which the data signal lines 11A and the data signal lines 11B, and the like have been formed. Specifically, an inorganic interlayer insulating film (a passivation film), which is made of SiNx and has a thickness of approximately 3000 Å, is deposited by the CVD method by use of a mixed gas of SiH₄, NH₃, and N₂ so as to cover the entire substrate. An organic interlayer insulating film, which is made of positive photosensitive acrylic resin and has a thickness of 3 μm, is further deposited by a spin coat method or a dye coat method.

Thereafter, patterning of contact holes is carried out with respect to the organic interlayer insulating film by use of the PEP technique, and then the organic interlayer insulating film is sintered. Furthermore, the inorganic interlayer insulating film, or the inorganic interlayer insulating film and the gate insulating film is/are removed by etching by use of a pattern of the organic interlayer insulating film, so as to form contact holes.

Subsequently, a transparent electroconductive film, which is made of a material such as ITO (Indian Tin Oxide), IZO (Indium Zinc Oxide), zinc oxide, or tin oxide and has a thickness of 1000 Å to 2000 Å, is deposited by the sputtering method throughout the substrate above the interlayer insulating film having the contact holes. Thereafter, the transparent electroconductive film is patterned by the PEP technique, and is subjected to resist removal, so as to form the pixel electrodes 14A and the pixel electrodes 14B.

Finally, a polyimide resin which has a thickness of 500 Å to 1000 Å is printed throughout the substrate 2 so as to cover the pixel electrodes 14A and the pixel electrodes 14B. Thereafter, the polyimide resin is sintered and then rubbed by use of a rotating cloth in one direction, so as to form an alignment film. The active matrix substrate 4 is thus produced.

The following description discusses the step of producing the color filter substrate 5.

First, a chromium thin film or a resin film containing a black pigment is deposited on a substrate made of a material such as glass or plastic (on the entire counter substrate), and is then patterned by the PEP technique so as to form a black matrix. Next, red, green and blue color filter layers (which have a thickness of approximately 2 μm) are patterned in gaps on the black matrix by a pigment dispersion method or the like.

Subsequently, a transparent electroconductive film, which is made of a material such as ITO, IZO, zinc oxide, tin oxide, or the like and has a thickness of approximately 1000 Å, is deposited throughout the substrate above the color filter layers so as to form the counter electrode 15 (com).

Finally, polyimide resin which has a thickness of 500 Å to 1000 Å is printed throughout the substrate 2 so as to cover the counter electrode 15. Thereafter, the polyimide resin is sintered and then rubbed by use of a rotating cloth in one direction, so as to form an alignment film. The color filter substrate can thus be produced.

The following description discusses the step of carrying out the assembly.

First, a sealing material made of a material such as a thermosetting epoxy resin is applied, by screen printing, to one of the active matrix substrate 4 and the color filter substrate 5, in a frame-shaped pattern such that no sealing material is applied to a part in which a liquid crystal filling opening is provided. Then, spherical spacers, which have a diameter equivalent to a thickness of a liquid crystal layer and are made of plastic or silica, are dispersed on the other of the active matrix substrate 4 and the color filter substrate 5. Note that instead of dispersing spacers, it is possible to form spacers on a black matrix of the color filter substrate 5 or on metal wiring of the active matrix substrate 4 by the PEP technique.

Next, the active matrix substrate 4 and the color filter substrate 5 are combined, and then the sealing material is cured.

Finally, a liquid crystal material is filled, via a liquid crystal filling opening, into a space defined by the active matrix substrate 4, the color filter substrate 5, and the sealing material by a decompression method. Then, UV-cured resin is applied to the liquid crystal filling opening so as to seal the liquid crystal material by UV irradiation. This causes the liquid crystal layer 6 to be formed.

The display panel 10A and the display panel 10B are thus produced in respective different regions of a single substrate in a single production process.

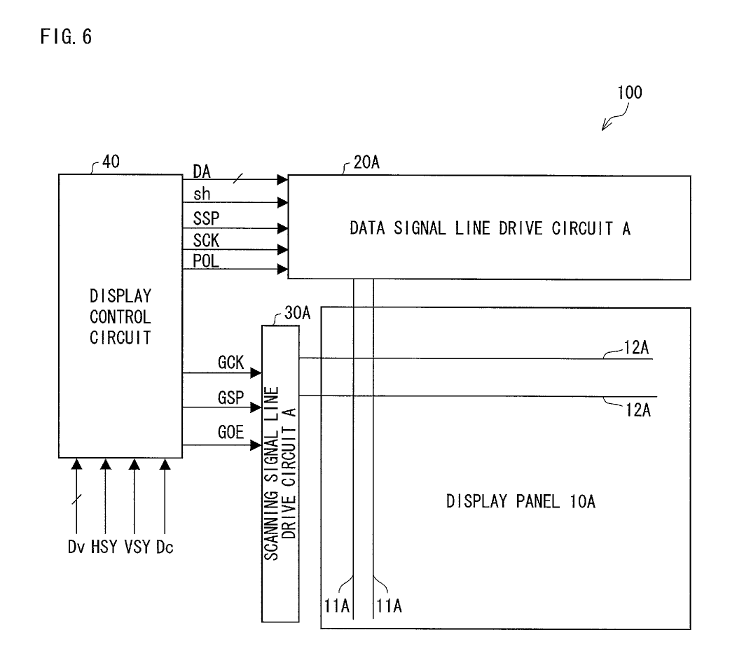

Next, the following description discusses an example of a basic method for driving the display device 100 of the present embodiment. Note that, since the display panel 10A and the display panel 10B can be driven separately, the description is given here by taking the display panel 10A as an example. FIG. 6 is a block diagram showing a method for driving the liquid crystal device 100.

The display control circuit 40 receives, from an external signal source (e.g., a tuner), a digital video signal Dv indicative of an image to be displayed, a horizontal synchronization signal HSY and a vertical synchronization signal VSY which correspond to the digital video signal Dv, and a control signal Dc for controlling a display operation. In response to the digital video signal Dv, the horizontal synchronization signal HSY, the vertical synchronization signal VSY, and the control signal Dc thus received, the display control circuit 40 generates and outputs, as signals for causing the display section to display an image indicated by the digital video signal Dv, the following signals: a data start pulse signal SSP; a data clock signal SCK; a charge sharing signal sh; a digital image signal DA indicative of the image to be displayed (i.e., a signal corresponding to the digital video signal Dv); a gate start pulse signal GSP; a gate clock signal GCK; and a gate driver output control signal (a scanning signal output control signal) GOE.

More specifically, the digital video signal Dv is subjected to, for example, a timing adjustment in an internal memory, as needed. Then, the digital video signal Dv is supplied from the display control circuit 40 as the digital image signal DA. The display control circuit 40 generates the data clock signal SCK as a signal which has pulses corresponding to pixels of the image indicated by the digital image signal DA. The display control circuit 40 (i) generates, in response to the horizontal synchronization signal HSY, the data start pulse signal SSP as a signal which has a High level (an H level) only for a predetermined period in each horizontal scanning period, (ii) generates, in response to the vertical synchronization signal VSY, the gate start pulse signal GSP as a signal which has an H level only for a predetermined period in each frame period (i.e., in each vertical scanning period), (iii) generates the gate clock signal GCK in response to the horizontal synchronization signal HSY, and (iv) generates the charge sharing signal sh and the gate driver output control signal GOE in response to the horizontal synchronization signal HSY and the control signal Dc.

Of the signals thus generated in the display control circuit 40, the digital image signal DA, the charge sharing signal sh, a signal POL for controlling a polarity of a signal electric potential (a data signal electric potential), the data start pulse signal SSP, and the data clock signal SCK are supplied to the data signal line drive circuit 20A. The gate start pulse signal GSP, the gate clock signal GCK, and the gate driver output control signal GOE are supplied to the scanning signal line drive circuit 30A.

In response to the digital image signal DA, the data clock signal SCK, the charge sharing signal sh, the data start pulse signal SSP, and the polarity inversion signal POL, the data signal line drive circuit 20A sequentially generates, in each horizontal scanning period, analog electric potentials (signal electric potentials) which correspond to respective pixel values of the image indicated by the digital image signal DA for each of the scanning signal lines 12A. The data signals thus generated are supplied from the data signal line drive circuit 20A to the data signal lines 11A.

The scanning signal line drive circuit 30A generates gate ON pulse signals in response to the gate start pulse signal GSP, the gate clock signal GCK, and the gate driver output control signal GOE. Then, the scanning signal line drive circuit 30A supplies the gate ON pulse signals to the respective scanning signal lines 12A. This causes the scanning signal lines 12A to be selectively driven.

Thus, the data signal line drive circuit 20A drives the data signal lines 11A of the display panel 10A while the scanning signal line drive circuit 30A drives the scanning signal lines 12A of the display panel 10A. This causes a signal electric potential to be written from a data signal line 11A to a pixel electrode 14A via a transistor 13A connected to a selected scanning signal line 12A. This causes a voltage to be applied to the liquid crystal layer 6 corresponding to each of the pixels PA so that a transmitted amount of light emitted from a backlight is controlled. As a result, the image indicated by the digital video signal Dv is displayed by each of the pixels PA.

Next, the following description discusses an arrangement example of the liquid crystal display device 100 of First Embodiment of the present invention. FIG. 7 is an equivalent circuit diagram partially illustrating the display panel 10A and the display panel 10B of the liquid crystal display device 100 in accordance with an arrangement example 1. According to the liquid crystal display device 100 of the arrangement example 1, the display panel 10A and the display panel 10B are identical in arrangement (see FIG. 7). Note that for convenience, the display panel 10A and the display panel 10B are juxtaposed to each other in a transverse direction of a page on which FIG. 7 is drawn. However, a direction in which the display panel 10A and the display panel 10B are juxtaposed to each other is not limited.

According to the display panel 10A, the data signal lines 11A extending in a column direction are sequentially provided, and the scanning signal lines 12A extending in a row direction are sequentially provided, and the retention capacitor lines 16A extending in the row direction are sequentially provided so as to be paired with the respective scanning signal lines 12A. The pixels PA are provided at the intersections of the data signal lines 11A and the scanning signal lines 12A. The pixel electrodes 14A, which are provided to the respective pixels PA, are connected to the data signal lines 11A via the respective transistors 13A which are connected to the scanning signal lines 12A. According to the arrangement, retention capacitors ChA are defined between the respective pixel electrodes 14A and the retention capacitor lines 16A, and liquid crystal capacitors CIA are defined between the respective pixel electrodes 14A and respective counter electrodes (com).

Similarly, according to the display panel 10B, the data signal lines 11B extending in a column direction are sequentially provided, and the scanning signal lines 12B extending in a row direction are sequentially provided, and the retention capacitor lines 16B extending in the row direction are sequentially provided so as to be paired with the respective scanning signal lines 12B. The pixels PB are provided at the intersections of the data signal lines 11B and the scanning signal lines 12B. The pixel electrodes 14B, which are provided to the respective pixels PB, are connected to the data signal lines 11B via the respective transistors 13B which are connected to the scanning signal lines 12B. According to the arrangement, retention capacitors ChB are defined between the respective pixel electrodes 14B and the retention capacitor lines 16B, and liquid crystal capacitors CIB are defined between the respective pixel electrodes 14B and respective counter electrodes (com).

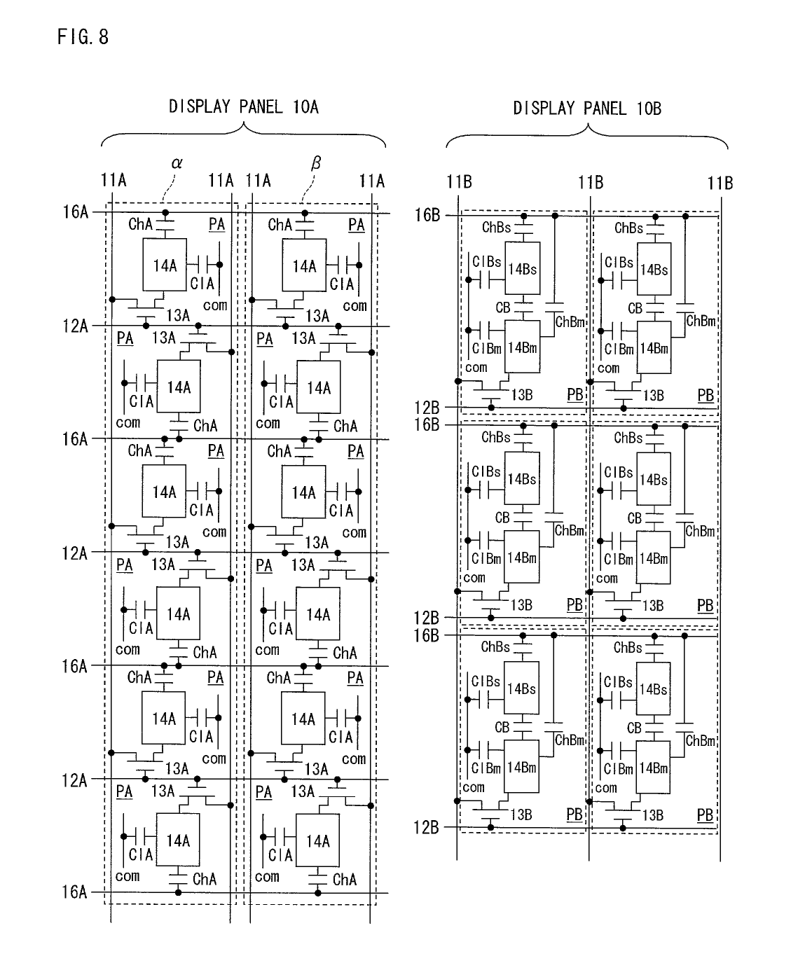

FIG. 8 is an equivalent circuit diagram partially illustrating the display panel 10A and the display panel 10B of the liquid crystal display device 100 in accordance with an arrangement example 2. According to the liquid crystal display device 100 of the arrangement example 2, the data signal lines 11A, the scanning signal lines 12A, the transistors 13A, the pixel electrodes 14A, and the retention capacitor lines 16A of the display panel 10A are different in arrangement from the data signal lines 11B, the scanning signal lines 12B, the transistors 13B, the pixel electrodes 14B, and the retention capacitor lines 16B, respectively, of the display panel 10B (see FIG. 8).

According to the display panel 10A, two of the signal lines 11A are provided for each one pixel column, and, one of the scanning signal lines 12A and one of the retention capacitor lines 16A are provided to every two pixels which are adjacent to each other in a column direction. In each of pixel columns α and β, a first pixel electrode 14A and a second pixel electrode 14A of one and the other, respectively of any two pixels PA that are adjacent to each other in a column direction are connected via a first transistor 13A and a second transistor 13A, respectively to a first data signal line 11A and a second data signal line 11A, respectively, which are different from each other. The retention capacitors ChA are defined between the respective pixel electrodes 14A and the retention capacitor lines 16A, and the liquid crystal capacitors C1A are defined between the respective pixel electrodes 14A and the respective counter electrodes (com).

The arrangement in which a data signal potential can be written simultaneously to any two adjacent pixels allows a screen to be rewritten at a higher speed, and allows an increase in charging time for each of the pixels.

Meanwhile, according to the display panel 10B, two pixel electrodes (a main pixel electrode 14Bm and a subpixel electrode 14Bs) are provided in each of the pixels PB. The main pixel electrode 14 Bm is connected to a corresponding data signal line 11B via a corresponding transistor 13B connected to a corresponding scanning signal line 12B. The sub pixel electrode 14Bs is connected (capacitively coupled) to the main pixel electrode 14Bm via a corresponding capacitor CB. A retention capacitor ChBm is defined between the main pixel electrode 14Bm and a corresponding retention capacitor line 16B, and a retention capacitor ChBs is defined between the subpixel electrode 14Bs and the corresponding retention capacitor line 16B. A liquid crystal capacitor C1Bm is defined between the main pixel electrode 14Bm and a corresponding counter electrode (com), and a liquid crystal capacitor C1Bs is defined between the subpixel electrode 14Bs and the corresponding counter electrode (com). The coupling capacitor CB is defined between the main pixel electrode 14Bm and the subpixel electrode 14Bs.

According to the arrangement in which a subpixel including the main pixel electrode 14Bm can be a bright subpixel and a subpixel including the subpixel electrode 14Bs can be a dark subpixel, it is possible to display a halftone by use of a bright sub pixel and a dark pixel. This enables an improvement in viewing angle characteristic. Note that not less than 3 pixel electrodes can be provided to one (1) pixel electrode PB.

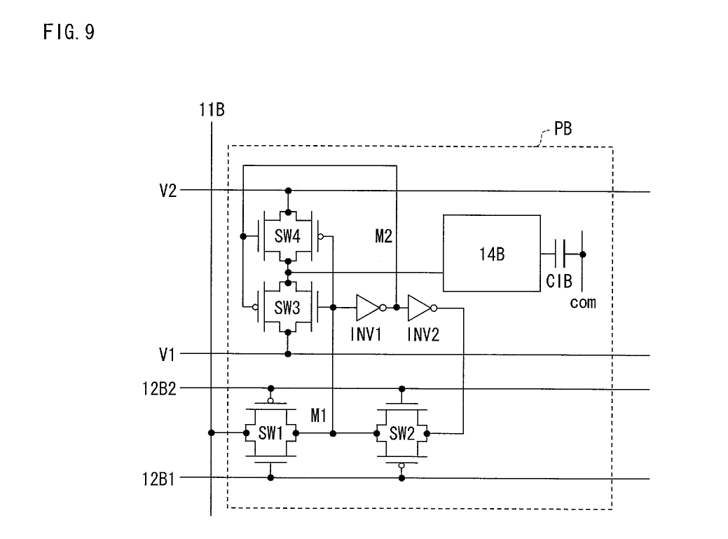

An embodiment in which the display panel 10A and the display panel 10B are different in pixel arrangement is exemplified by an embodiment which serves as another arrangement (an arrangement example 3) and in which a DRAM and an SRAM are used in combination. According to the liquid crystal display device 100 of the arrangement example 3, for example, the display panel 10A can have a DRAM pixel arrangement (see FIG. 7), and the display panel 10B can have an SRAM pixel arrangement (see FIG. 9). The following description discusses the SRAM pixel arrangement to be applied to the display panel 10B. FIG. 9 schematically illustrates an electrical configuration of one (1) pixel PB. In FIG. 9, reference signs 12B1 and 12B2 both indicate scanning signal lines. The scanning signal line 12B2 receives an inversion signal of data which is supplied to the scanning signal line 12B1. Reference signs SW1 to SW4 indicate switching circuits, reference signs INV1 and INV2 indicate inverters, reference signs M1 and M2 indicate memory signals, and reference signs V1 and V2 indicate pixel electrode signals.

The switching circuit SW1 and the switching circuit SW2 carry out respective operations which are opposite to each other. For example, the switching circuit SW2 is off (closed) when the switching circuit SW1 is on (open), whereas the switching circuit SW2 is on (open) when the switching circuit SW1 is off (closed).

The scanning signal line 12B2 receives an inversion signal of data which is supplied to the scanning signal line 12B1. Therefore, for example, the scanning signal line 12B2 is at a low level when the scanning signal line 12B1 is at a high level, whereas the scanning signal line 12B2 is at a high level when the scanning signal line 12B1 is at a low level.

Note here that, when the scanning signal line 12B1 is at a high level (the scanning signal line 12B2 is at a low level), the switching circuit SW1 turns on (is open). Then, data of the data signal line 11B pass through the switching circuit SW1, and the data is written to the memory signal M1.

Next, when the scanning signal line 12B1 is at a low level (the scanning signal line 12B2 is at a high level), the switching circuit SW2 turns on (is open), and the data written to the memory signal M1 is maintained (stored) in the inverter INV1, the memory signal M2, the inverter INV2, the switching circuit SW2, and the memory signal M1 in this order.

Note that the switching circuit SW1 is off (is closed) in this case. Therefore, even if data (a level) of the scanning signal line 11B changes, an electric potential level of the data of the memory signal M1 is maintained (stored) without being affected.

At this point, a level of the memory signal M2 is inverse to a level of the memory signal M1. The switching circuit SW3 and the switching circuit SW4 carry out respective operations which are opposite to each other. For example, the switching circuit SW4 is off (closed) when the switching circuit SW3 is on (open), whereas the switching circuit SW4 is on (open) when the switching circuit SW3 is off (closed).

According to this, when the memory signal M1 is at a high level (the memory signal M2 is at a low level), the switching circuit SW3 is on (open), and the pixel electrode signal V1 is written to a pixel electrode 14B.

In contrast, when the memory signal M1 is at a low level (the memory signal M2 is at a high level), the switching circuit SW4 is on (open), and the pixel electrode signal V2 is written to the pixel electrode 14B.

Note that each of the pixel electrode signal V1 and the pixel electrode signal V2 set an electric potential (a level) of a pixel electrode. For example, the pixel electrode signal V1 sets a level corresponding to black, and the pixel electrode signal V2 sets a level corresponding to white.

This causes either the pixel electrode signal V1 or the pixel electrode signal V2 to be written to the pixel electrode 14B in accordance with a level of data stored in the memory signal M1.

Note that an arrangement of the display panel 10A and the display panel 10B is not limited to the arrangement examples described above and the display panel 10A and the display panel 10B can be arranged by combining various embodiments.

### Second Embodiment

A liquid crystal display device 200 of Second Embodiment of the present invention is described below. Note that for convenience, members having functions identical to those of the respective members described in First Embodiment are given respective identical reference numerals, and a description of those members is omitted here. Note also that terms defined in First Embodiment are used in Second Embodiment in accordance with the definition unless otherwise noted.

According to the liquid crystal display device 100 in accordance with First Embodiment (described earlier), the counter electrode 15 is provided so as to be shared by the display panel 10A and the display panel 10B. Meanwhile, according to the liquid crystal display device 200 of the present embodiment, a display panel 10A and a display panel 10B are provided with respective counter electrodes.

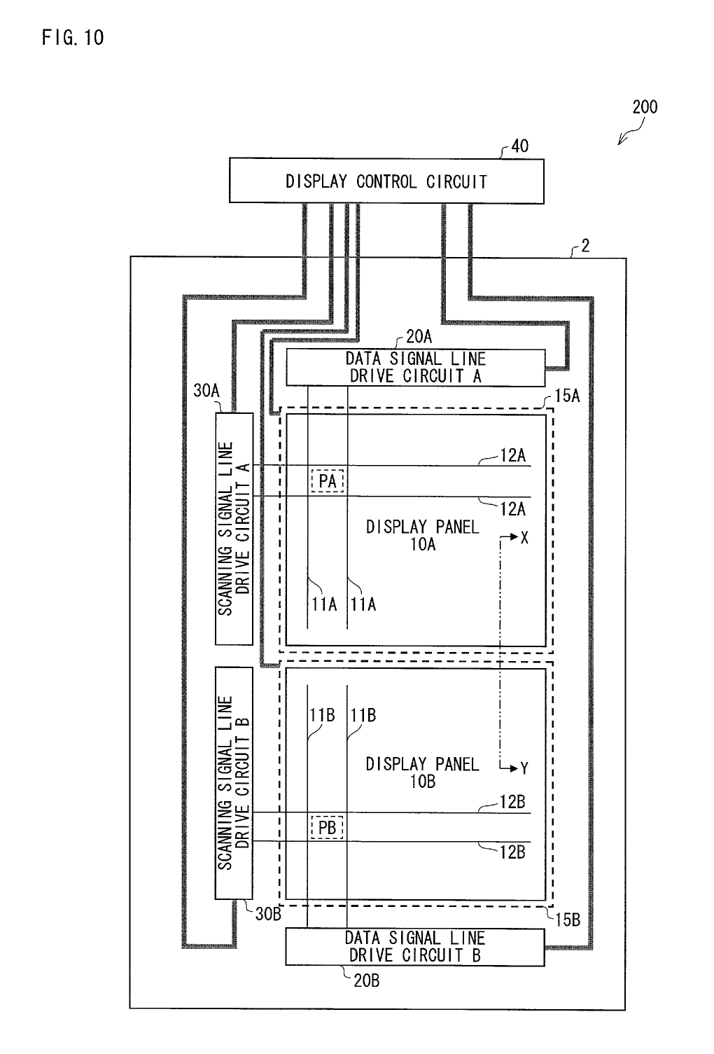

FIG. 10 is a block diagram illustrating an overall arrangement of the liquid crystal display device 200. The display panel 10A is provided with a counter electrode 15A, and the display panel 10B is provided with a counter electrode 15B (see FIG. 10). A display control circuit 40 supplies a counter electrode electric potential COM_A and a counter electrode electric potential COM_B to the counter electrode 15A and the counter electrode 15B, respectively.

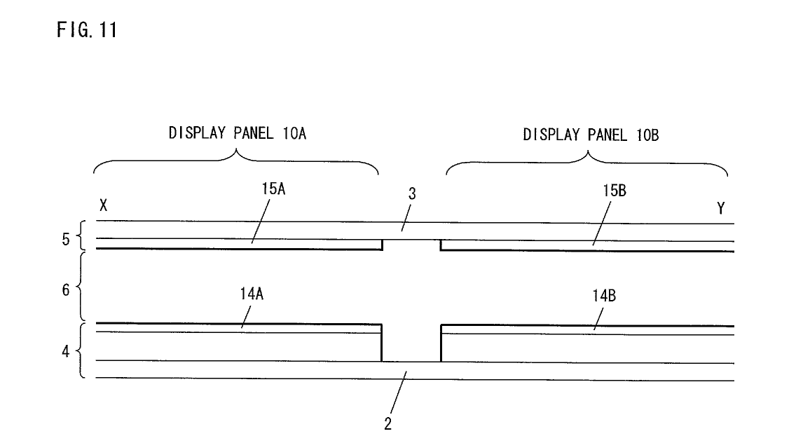

FIG. 11 is a schematic cross-sectional view taken along arrows X-Y of FIG. 10. An active matrix substrate 4 of the present embodiment and the active matrix substrate 4 of the liquid crystal display device 100 in accordance with First Embodiment (see FIG. 5) are identical in arrangement. Meanwhile, according to a color filter substrate 5 of the present embodiment, there are provided a glass substrate (a counter substrate) 3, a black matrix (not illustrated) and a colored layer (a color filter layer) (not illustrated) which are provided on the glass substrate 3, a counter electrode 15A which is provided on the colored layer in a region in which the display panel 10A is provided, a counter electrode 15B which is provided in a region in which the display panel 10B is provided, and an alignment film which is provided so as to cover counter electrode 15A and the counter electrode 15B.

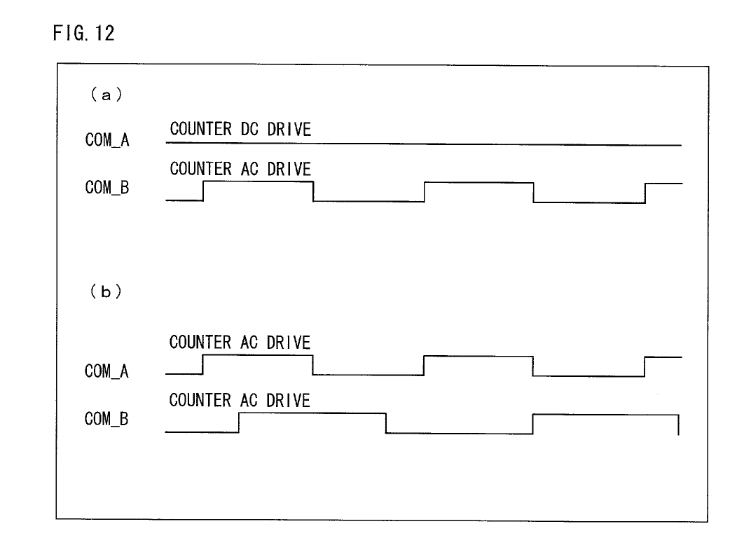

As described earlier, according to the liquid crystal display device 200, the display panel 10A and the display panel 10B are provided in respective different regions of a single substrate 1, and a drive circuit, signal lines, and a counter electrode are provided for each of the display panel 10A and the display panel 10B. This allows greater design freedom to be given to a method for driving a liquid crystal display device. For example, in a case where a voltage to be supplied to the counter electrode 15A is set to a direct-current voltage and a voltage to be supplied to the counter electrode 15B is set to an alternating-current voltage, the display panel 10A can be subjected to DC drive, and the display panel 10B can be subjected to AC drive (see (a) of FIG. 12). Alternatively, the display panel 10A and the display panel 10B can be driven at different timings by setting voltages to be supplied to the counter electrode 15A and the counter electrode 15B, respectively, to alternating-current voltages and causing the voltages to be different in period (frequency) (see (b) of FIG. 12).

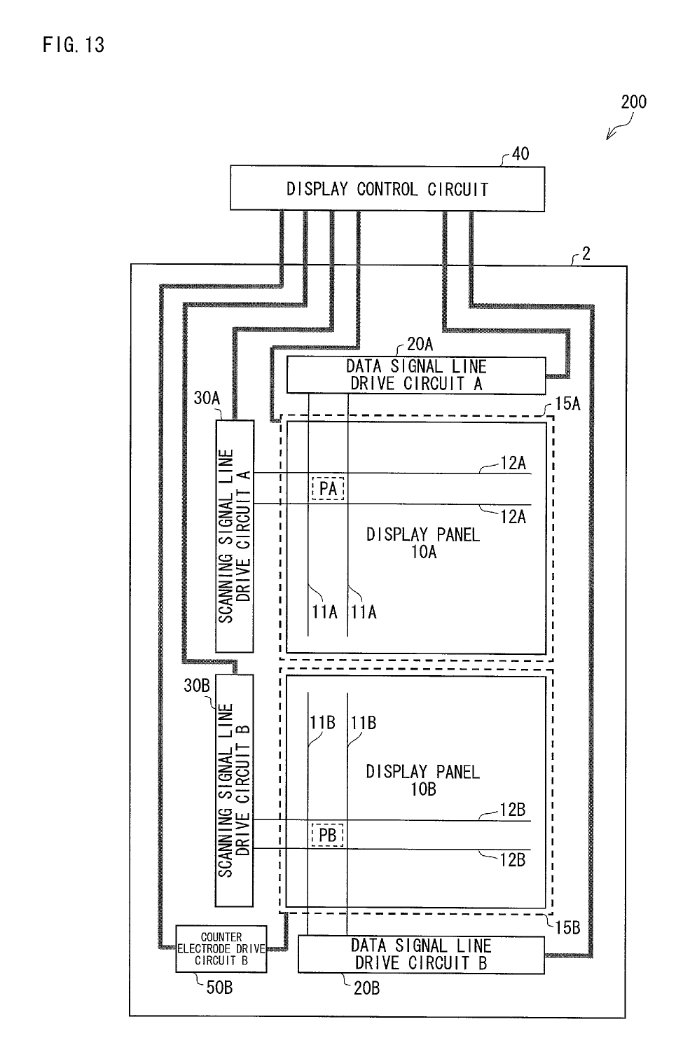

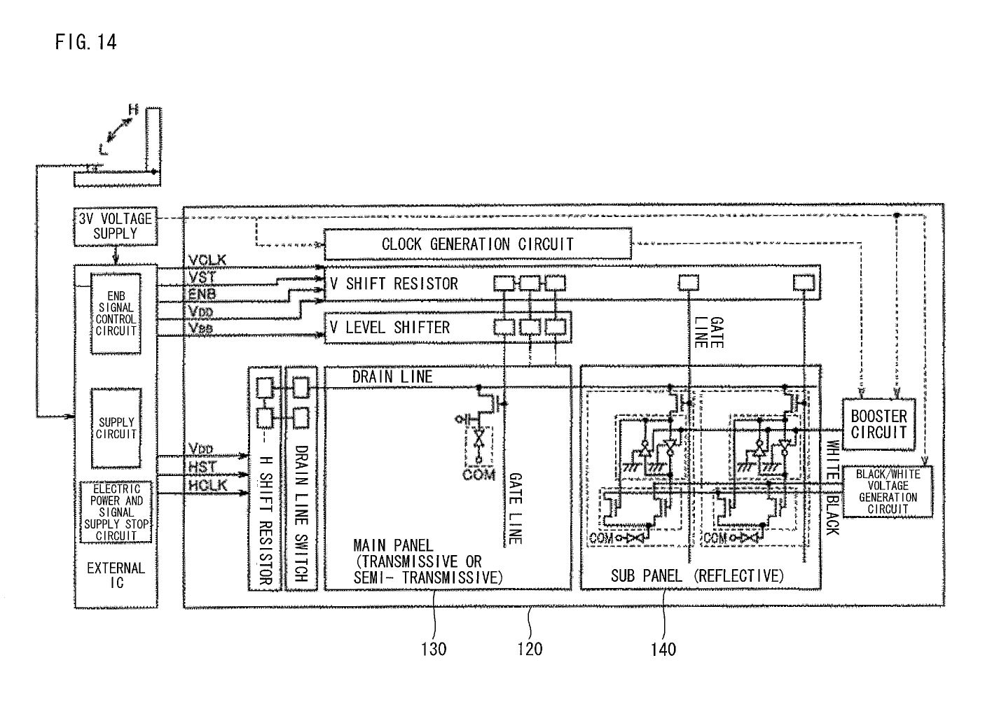

Note here that the liquid crystal display device 200 in accordance with the second embodiment can be arranged as below. FIG. 13 is a block diagram illustrating an overall arrangement of the liquid crystal display device 200 in accordance with an arrangement example 4. The liquid crystal display device 200 in accordance with the arrangement example 4 includes a counter electrode drive circuit 50B which is provided so as to correspond to the display panel 10B (see FIG. 13). The counter electrode drive circuit 50B generates the counter electrode electric potential COM_B in accordance with a signal received from an outside, and supplies the counter electrode electric potential COM_B to the counter electrode 15B.

Note that according to the arrangement example 4, the display control circuit 40 supplies the counter electrode electric potential COM_A to be applied to the counter electrode 15A. However, an arrangement in which the counter electrode electric potential COM_A is supplied to the counter electrode 15A is not limited to this. Alternatively, as in the case of the display panel 10B, a counter electrode drive circuit 50A (not illustrated) can be provided so as to generate the counter electrode potential COM_A and supply the counter electrode potential COM_A to the counter electrode 15A.

Note that the driving methods the production method each of which has been described in First Embodiment is applicable to the liquid crystal display device 200 in accordance with Second Embodiment. Note that it is needless to say that embodiments of the display panel 10A and the display panel 10B which embodiments are described in the arrangement examples 1 through 3 of First Embodiment are applicable to the display panel 10A and the display panel 10B of the liquid crystal display device 200.

Each of the liquid crystal display device 100 and the liquid crystal display device 200 (which have been described earlier) includes two display panels which are the display panel 10A and the display panel 10B and are provided on one (1) substrate. However, an arrangement of a liquid crystal display device of the present invention is not limited to this. The liquid crystal display device of the present invention can be arranged to include: not less than 3 display panels which are provided on one (1) substrate; and drive circuits (data signal line drive circuits and scanning signal line drive circuits) which are provided for the respective not less than 3 display panels.

As described earlier, a display device in accordance with the present invention includes: a plurality of display panels which are provided on a single substrate; a plurality of data signal lines which are provided for each of the plurality of display panels; a plurality of scanning signal lines which are provided for each of the plurality of display panels; a data signal line drive circuit which is provided for each of the plurality of display panels and drives the plurality of data signal lines; and a scanning signal line drive circuit which is provided for each of the plurality of display panels and drives the plurality of scanning signal lines.

According to the arrangement, display panels are provided in respective different regions of a single substrate, and drive circuits and signal lines are provided for each of the plurality of display panels. This makes it possible to drive the display panels separately. For example, assume that two display panels which are a display panel A and a display panel B are provided. In this case, in accordance with a situation in which the display panel A and the display panel B are used, driving of the display panel A and the display panel B can be controlled such that (1) both the display panel A and the display panel B are driven, (2) the display panel A is driven, and the display panel B is not driven, (3) the display panel A is not driven, and the display panel B is driven, or (4) neither the display panel A nor the display panel B is driven. This enables lower electric power consumption and greater design freedom.

The display device can be arranged to further include counter electrodes which are provided for the respective plurality of display panels.

The display device can be arranged such that the counter electrodes are supplied with respective different electric potentials.

The display device can also be arranged such that the plurality of display panels are constituted by (i) a display panel that is provided with a counter electrode to which a direct-current voltage is supplied and (ii) a display panel that is provided with a counter electrode to which an alternating-current voltage is supplied.

According to the arrangement, since counter electrodes are provided for each of display panels, it is possible to give greater design freedom to a method for driving a liquid crystal display device. For example, in a case where a voltage to be supplied to a first counter electrode is set to a direct-current voltage, a corresponding display panel can be subjected to DC drive. Meanwhile, in a case where a voltage to be supplied to a second counter electrode is set to an alternating-current voltage, a corresponding display panel can be subjected to AC drive.

The display device can be arranged to further include: a counter electrode which is shared by the plurality of display panels, the counter electrode being supplied with a constant electric potential.

This enables a simpler arrangement of a display device and lower electric power consumption.

The display device can be arranged such that the plurality of data signal lines and the plurality of scanning signal lines differ in number between the plurality of display panels.

The present invention is not limited to the description of embodiments above, but an embodiment based on a proper alteration of the embodiments based on common general technical knowledge and an embodiment based on a combination of the embodiments are encompassed in the embodiments of the present invention.

### INDUSTRIAL APPLICABILITY

A display device of the present invention is suitable for an electronic device including a plurality of display sections.

### REFERENCE SIGNS LIST

2, 3 Glass substrate (Substrate)
10A, 10B Display panel
20A, 20B Data signal line drive circuit
30A, 30B Scanning signal line drive circuit
40 Display control circuit
50A, 50B Counter electrode drive circuit
11A, 11B Data signal line
12A, 12B Scanning signal line
13A, 13B Transistor
14A, 14B Pixel electrode
15A, 15B Counter electrode
16A, 16B Retention capacitor line
100, 200 Liquid crystal display device
PA, PB Pixel

1. A display device comprising:
a plurality of display panels which are provided on a single substrate;
a plurality of data signal lines which are provided for each of the plurality of display panels;
a plurality of scanning signal lines which are provided for each of the plurality of display panels;
a data signal line drive circuit which is provided for each of the plurality of display panels and drives the plurality of data signal lines; and
a scanning signal line drive circuit which is provided for each of the plurality of display panels and drives the plurality of scanning signal lines.

2. The display device as set forth in claim 1, further comprising counter electrodes which are provided for the respective plurality of display panels.

3. The display device as set forth in claim 2, wherein the counter electrodes are supplied with respective different electric potentials.

4. The display device as set forth in claim 2, wherein the plurality of display panels are constituted by (i) a display panel that is provided with a counter electrode to which a direct-current voltage is supplied and (ii) a display panel that is provided with a counter electrode to which an alternating-current voltage is supplied.

5. The display device as set forth in claim 1, further comprising:
a counter electrode which is shared by the plurality of display panels,
the counter electrode being supplied with a constant electric potential.

6. The display device as set forth in claim 1, wherein the plurality of data signal lines and the plurality of scanning signal lines differ in number between the plurality of display panels.
